(19) United States
(12) Patent Application Publication
(10) Pub. No.: US 2005/0086292 A1
(43) Pub. Date: Apr. 21, 2005

(54) Method and apparatus for supporting preprocessing in a Web presentation architecture

(76) Inventor: Sunny K. Yee, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/676,328

(22) Filed: Oct. 1, 2003

(51) Int. Cl. G06F 15/16

(52) U.S. Cl. 709/203; 709/219

(57) ABSTRACT

The disclosed embodiments relate to a system and method that creates applications. The system comprises a controller generator that is adapted to provide an application with a controller that receives requests for data from users and responds to the requests by obtaining requested data. The system also comprises a preprocessor manager that is adapted to process a preprocessor action for use by the controller during a user session at a portal.

### BACKGROUND OF THE RELATED ART

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Presentations and applications are continuously developing on the World Wide Web (the “Web), which has undergone an explosive growth in recent years. Early Web applications largely involved simple presentations of data, such as a corporate website displaying personnel information, contact information, and other static information. However, the current trend of Web applications involves a dynamic exchange of data, complicated logic and functionality, animated graphics, and an international focus. As a result, the content and functionality of Web applications are becoming increasingly complex and difficult to manage. Web servers are faced with increasingly complex and voluminous processing functions to provide an appropriate response to a user request. Many of these processing functions are common to multiple user requests, yet existing Web servers repeat the common processing functions for each user request.

Accordingly, a technique is needed for efficiently processing common functions performed by the Web server.

### BRIEF DESCRIPTION OF THE DRAWINGS

Advantages of one or more disclosed embodiments may become apparent upon reading the following detailed description and upon reference to the drawings in which:

FIG. 1 is a block diagram that illustrates a model-view-controller (“MVC”) application architecture, which may be created using embodiments of the present invention;

FIG. 2 is a block diagram that illustrates a web presentation architecture in accordance with embodiments of the present invention;

FIG. 3 is a block diagram that illustrates a preprocessing system interacting with the present web presentation architecture of FIG. 2 in accordance with embodiments of the present invention;

FIG. 4 is a flow chart that illustrates a preprocessing setup process for the preprocessing system of FIG. 3 in accordance with embodiments of the present invention; and

FIG. 5 is a flow chart that illustrates a preprocessing process for the preprocessing system of FIG. 3 in accordance with embodiments of the present invention.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

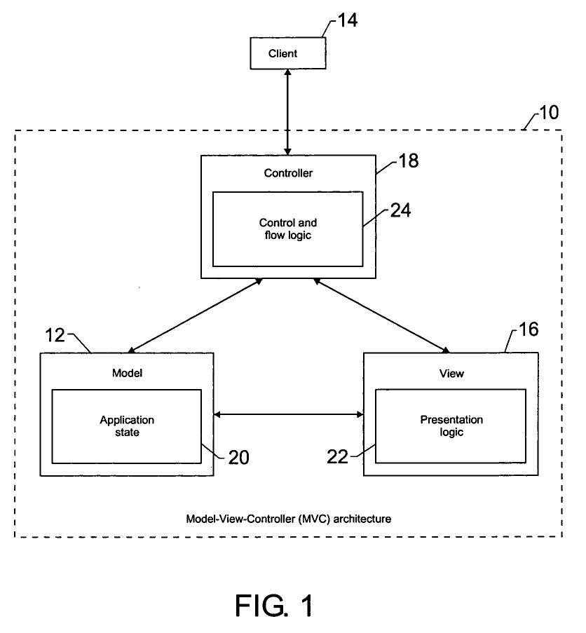

FIG. 1 is a block diagram that illustrates a model-view-controller (“MVC”) application architecture, which may be created using embodiments of the present invention. As illustrated, the MVC architecture 10 separates the application object or model 12 from a view 16, which is responsible for receiving an input and presenting an output to a client 14. In a web application context, the client 14 may comprise a browser. The model object and the view are also separated from the control functions of the application, which are represented in FIG. 1 as a controller 18. In general, the model 12 comprises an application state 20, the view 16 comprises presentation logic 22, and the controller 18 comprises control and flow logic 24. By separating these three MVC objects 12, 16, and 18 with abstract boundaries, the MVC architecture 10 may provide flexibility, organization, performance, efficiency, and reuse of data, presentation styles, and logic.

The WPA 100 may be configured with a variety of object-oriented programming languages, such as Java by Sun Microsystems, Inc., Santa Clara, Calif. An object is generally an item that can be individually selected and manipulated. In object-oriented programming, an object may comprise a self-contained entity having data and procedures to manipulate the data. For example, a Java-based system may utilize a variety of JavaBeans, servlets, Java Server Pages, and so forth. JavaBeans are independent, reusable software modules. In general, JavaBeans support introspection (a builder tool can analyze how a JavaBean works), customization (developers can customize the appearance and behavior of a JavaBean), events (JavaBeans can communicate), properties (developers can customize and program with JavaBeans), and persistence (customized JavaBeans can be stored and reused). JSPs provide dynamic scripting capabilities that work in tandem with HTML code, separating the page logic from the static elements. According to certain embodiments, the WPA 100 may be designed according to the Java 2 Platform Enterprise Edition (J2EE), which is a platform-independent, Java-centric environment for developing, building and deploying multi-tiered Web-based enterprise applications online.

The model 12 comprises a definitional framework representing the application state 20. For example, in a web-based application, the model 12 may comprise a JavaBean object or other suitable means for representing the application state 20. Regardless of the application or type of object, an exemplary model 12 may comprise specific data and expertise or ability (methods) to get and set the data (by the caller). The model 12 generally focuses on the intrinsic nature of the data and expertise, rather than the extrinsic views and extrinsic actions or business logic to manipulate the data. However, depending on the particular application, the model 12 may or may not contain the business logic along with the application state. For example, a large application having an application tier may place the business logic in the application tier rather than the model objects 12 of the web application, while a small application may simply place the business logic in the model objects 12 of the web application.

As noted above, the view and controller objects 16 and 18 separately address these extrinsic views and actions or business logic. For example, the model 12 may represent data relating to a person (e.g., an address, a birth date, phone number, etc.), yet the model 12 is independent of extrinsic formats (e.g., a date format) for displaying the personal data or extrinsic actions for manipulating the personal data (e.g., changing the address or phone number). Similarly, the model 12 may represent data and expertise to track time (e.g., a clock), yet the model 12 is independent of specific formats for viewing the clock (e.g., analog or digital clock) or specific actions for manipulating the clock (e.g., setting a different time zone). These extrinsic formats and extrinsic actions are simply not relevant to the intrinsic behavior of the model clock object. One slight exception relates to graphical model objects, which inherently represent visually perceptible data. If the model 12 represents a particular graphical object, then the model 12 has expertise to draw itself while remaining independent of extrinsic formats for displaying the graphical object or extrinsic actions for creating or manipulating the graphical object.

The view 16 generally manages the visually perceptible properties and display of data, which may be static or dynamic data derived in whole or in part from one or more model objects 12. As noted above, the presentation logic 22 functions to obtain data from the model 12, format the data for the particular application, and display the formatted data to the client 14. For example, in a web-based application, the view 16 may comprise a Java Server Page (JSP page) or an HTML page having presentation logic 22 to obtain, organize, format, and display static and/or dynamic data. Standard or custom action tags (e.g., jsp:useJavaBean) may function to retrieve data dynamically from one or more model objects 12 and insert model data within the JSP pages. In this manner, the MVC architecture 10 may facilitate multiple different views 16 of the same data and/or different combinations of data stored by one or more model objects 12.

The controller 18 functions as an intermediary between the client 14 and the model object 12 and view 16 of the application. For example, the controller 18 can manage access by the view 16 to the model 12 and, also, manage notifications and changes of data among objects of the view 16 and objects of the model 12. The control and flow logic 24 of the controller 18 also may be subdivided into model-controllers and view-controllers to address and respond to various control issues of the model 12 and the view 16, respectively. Accordingly, the model-controllers manage the models 12 and communicate with view-controllers, while the view-controllers manage the views 16 and communicate with the model-controllers. Subdivided or not, the controllers 18 ensure communication and consistency between the model 12, the view 16, and the client 14.

In operation, the control and flow logic 24 of the controller 18 generally receives requests from the client 14, interprets the client requests, identifies the appropriate logic function or action for the client requests, and delegates responsibility of the logic function or action. Requests may be received from the client via a number of protocols, such as Hyper Text Transfer Protocol (“HTTP”) or HTTP with Secure Sockets Layer (“HTTPS”). Depending on the particular scenario, the appropriate logic function or action of the controller 18 may include direct or indirect interaction with the view 16 and/or one or more model objects 12. For example, if the appropriate action involves alteration of extrinsic properties of data (e.g. reformatting data in the view 16), then the controller 18 may directly interact with the view 16 without the model 12. Alternatively, if the appropriate action involves alteration of intrinsic properties of data (e.g., values of data in the model 12), then the controller 18 may act to update the corresponding data in the model 12 and display the data in the view 16.

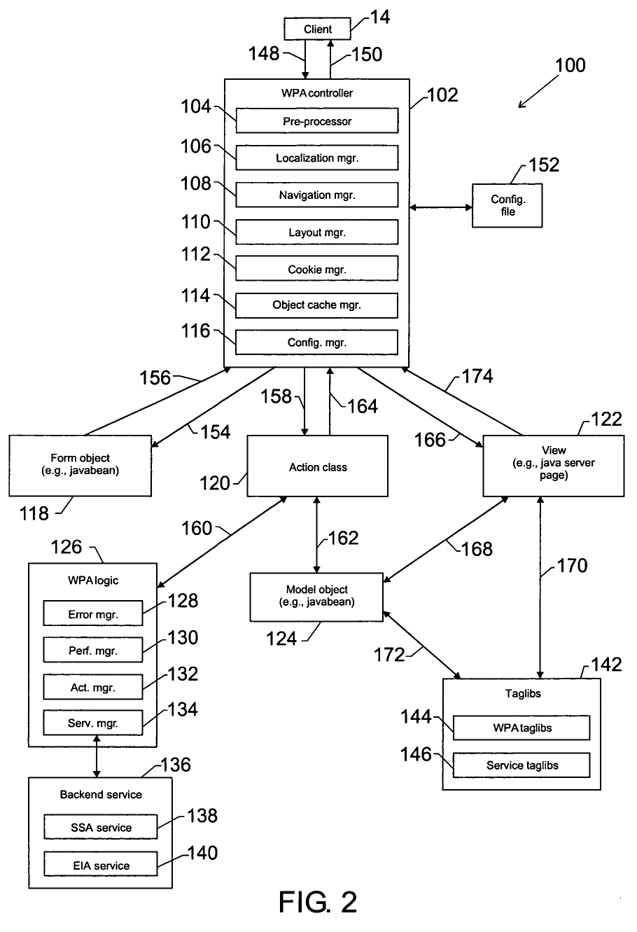

FIG. 2 is a block diagram illustrating an exemplary web presentation architecture (“WPA”) 100 in accordance with certain embodiments of the present invention. The illustrated WPA 100, which may be adapted to execute on a processor-based device such as a computer system or the like, has certain core features of the MVC computing strategy, and various additional features and enhancements to improve its architectural operation and performance. For example, the illustrated WPA 100 separates the model, the view, and the controller as with the traditional MVC architecture, yet the WPA 100 provides additional functionality to promote modularity, flexibility, and efficiency.

As illustrated, the WPA 100 comprises a WPA controller 102 having a preprocessor 104, a localization manager 106, the navigation manager 108, a layout manager 110, a cookie manager 112, and object cache manager 114, and a configurator or configuration manager 116. The WPA controller 102 functions as an intermediary between the client 14, form objects 118, action classes 120, and views 122. In turn, the action classes 120 act as intermediaries for creating/manipulating model objects 124 and executing WPA logic 126, such as an error manager 128, a performance manager 130, and activity manager 132, and a backend service manager 134. As described below, the backend service manager 134 functions to interface backend services 136. Once created, the model objects 124 can supply data to the view 122, which can also call various tag libraries 142 such as WPA tag libraries 144 and service tag libraries 146.

In operation, the client 14 sends a request 148 to the WPA 100 for processing and transmission of a suitable response 150 back to the client 14. For example, the request 148 may comprise a data query, data entry, data modification, page navigation, or any other desired transaction. As illustrated, the WPA 100 intakes the request 148 at the WPA controller 102, which is responsible for various control and flow logic among the various model-view-controller divisions of the WPA 100. For example, the WPA controller 102 can be implemented as a Servlet, such as a HyperText Transfer Protocol (“HTTP”) Servlet, which extends the ActionServlet class of Struts (an application framework promulgated by the Jakarta Project of the Apache Software Foundation). As illustrated, the WPA controller 102 invokes a configuration resource file 152, such as struts-config.xml, which provides mapping information for form classes, action classes, and other objects. Based on the particular request 148, the WPA controller 102 locates the appropriate action class and, also, the appropriate form class if the request 148 contains form data (e.g., client data input). For example, the WPA controller 102 may lookup a desired WPA Action Form and/or WPA Action Class, which function as interfaces to WPA Form Objects and WPA Action Objects.

If the client entered data, then the WPA controller 102 creates and populates the appropriate form object 118 as indicated by arrow 154. The form object 118 may comprise any suitable data objects type, such as a JavaBean, which functions to store the client entered data transmitted via the request 148. The WPA controller 102 then regains control as indicated by arrow 156.

If the client did not enter data, or upon creation and population of the appropriate form object 118, then the WPA controller 102 invokes the action class 120 to execute various logic suitable to the request 148 as indicated by arrow 158. For example, the action class 120 may call and execute various business logic or WPA logic 126, as indicated by arrow 160 and discussed in further detail below. The action class 120 then creates or interacts with the model object 124 as indicated by arrow 162. The model object 124 may comprise any suitable data object type, such as a JavaBean, which functions to maintain the application state of certain data. One example of the model object 124 is a shopping cart JavaBean, which stores various user data and e-commerce items selected by the client. However, a wide variety of model objects 124 are within the scope of the WPA 100. After executing the desired logic, the action class 120 forwards control back to the WPA controller 102 as indicated by arrow 164, which may be referred to as an “action forward.” This action forward 164 generally involves transmitting the path or location of the server-side page, e.g., the JSP.

As indicated by arrow 166, the WPA controller 12 then invokes the foregoing server-side page as the view 122. Accordingly, the view 122 interprets its links or tags to retrieve data from the model object 124 as indicated by arrow 168. Although a single model object 124 is illustrated, the view 122 may retrieve data from a wide variety of model objects. In addition, the view 122 interprets any special logic links or tags to invoke tag libraries 142 as indicated by arrow 170. For example, the WPA tag libraries 144 and the service tag libraries 146 can include various custom or standard logic tag libraries, such as <html>, <logic>, <template> developed as part of the Apache Jakarta Project or the like. Accordingly, the tag libraries 142 further separate the logic from the content of the view 122, thereby facilitating flexibility and modularity. In certain cases, the tag libraries 142 also may interact with the model object 124 as indicated by arrow 172. For example, a special tag may execute logic to retrieve data from the model object 124 and manipulate the retrieved data for use by the view 122. After interacting with the model object 124 and the appropriate tag libraries 142, the WPA 100 executes the view 122 (e.g., JSP) to create a client-side page for the client 14 as indicated by arrow 174. For example, the client-side page may comprise an XML or HTML formatted page, which the WPA controller 102 returns to the client 14 via the response 150.

As discussed above, the WPA 100 comprises a variety of unique logic and functional components, such as control components 104 through 116 and logic 128 through 134, to enhance the performance of the overall architecture and specific features 100. These components and logic generally operate on the server-side of the WPA 100, yet there are certain performance improvements that may be apparent on the client-side. These various components, while illustrated as subcomponents of the controller 102 or types of logic 126, may be standalone or integrated with various other portions of the WPA 100. Accordingly, the illustrated organization of these components is simply one exemplary embodiment of the WPA 100, while other organizational embodiments are within the scope of the present technique.

Turning to the subcomponents of the WPA controller 102, the preprocessor 104 provides preprocessing of requests by configuring portal specific functions to execute for each incoming request registered to the specific portal. The preprocessor 104 identifies the appropriate portal specific functions according to a preset mapping, e.g., a portal-to-function mapping in the configuration file 152. Upon completion, the preprocessor 104 can redirect to a remote Uniform Resource Identifier (URI), forward to a local URI, or return and continue with the normal processing of the request 148 by the WPA controller 102. One example of such a preprocessing function is a locale, which is generally comprised of language preferences, location, and so forth. The preprocessor 104 can preprocess local logic corresponding to a particular portal, thereby presetting language preferences for subsequent pages in a particular application.

The locale information is also used by the localization manager 106, which functions to render localized versions of entire static pages. Instead of using a single page for all languages and obtaining localized strings from other sources at run time, the localization manager 106 looks up a localized page according to a locale identifier according to a preset mapping, e.g., a locale-to-localized page mapping in the configuration file 152. For example, the localization manager 106 is particularly useful for static information, such as voluminous help pages.

The navigation manager 108 generally functions to identify a user's intended destination and subsequently recall that information to redirect the user back to the intended destination. For example, if the user intends to navigate from point A to point B and point B queries for certain logic at point C (e.g., a user login and password), then the navigation manager 108 saves the address of point B, proceeds to the requested logic at point C, and subsequently redirects the user back to point B.

The layout manager 110 enables a portal to separate the context logic functioning to render the common context from the content logic functioning to render the content portion of the page. The common context (e.g., C-Frame) may include a top portion or header, a bottom portion or footer, and a side portion or sidebar, which collectively provides the common look and feel and navigational context of the page.

The cookie manager 112 functions to handle multiple cookie requests and to set the cookie value based on the most recent cookie request before committing a response. For example, in scenarios where multiple action classes attempt to set a particular cookie value, the cookie manager 112 caches the various cookie requests and defers setting the cookie value until response time. In this manner, the cookie manager 112 ensures that different action classes do not erase cookie values set by one another and, also, that only one cookie can exist with a particular name, domain, and path.

The object cache manager 114 enables applications to create customized in-memory cache for storing objects having data originating from backend data stores, such as databases or service based frameworks (e.g., Web Services Description Language “WSDL”). The in-memory cache may be customized according to a variety of criteria, such as cache size, cache scope, cache replacement policy, and time to expire cache objects. In operation, the object cache manager 114 improves performance by reducing processing time associated with the data from the backend data stores. Instead of retrieving the data from the backend data stores for each individual request 148, the object cache manager 114 caches the retrieved data for subsequent use in processing later requests.

The configurator or configuration manager 116 functions to load frequently used information, such as an error code table, into memory at startup time of a particular web application. The configuration manager 116 retains this information in memory for the duration of a session, thereby improving performance by eliminating the need to load the information each time the server receives a request.

Turning to the WPA logic 126, the error handler or manager 128 functions to track or chain errors occurring in series, catalog errors messages based on error codes, and displaying error messages using an error catalog. The error catalog of the error manager 128 may enable the use of generic error pages, which the error manager 128 populates with the appropriate error message at run time according to the error catalog.

The WPA logic function 126 may comprise performance and activity managers 130 and 132, which may facilitate tracking and logging of various information associated with a particular transaction or request. The error manager 128 may also be adapted to participate in tracking and logging operations as well.

The service manager 134 of the WPA logic 126 functions as an interface between the WPA 100 and various backend services 136. In operation, the service manager 134 communicates with the desired backend service 136 according to the client request 148, parses a response from the backend service 136 to obtain the appropriate data, and pass it to the appropriate object of WPA 100.

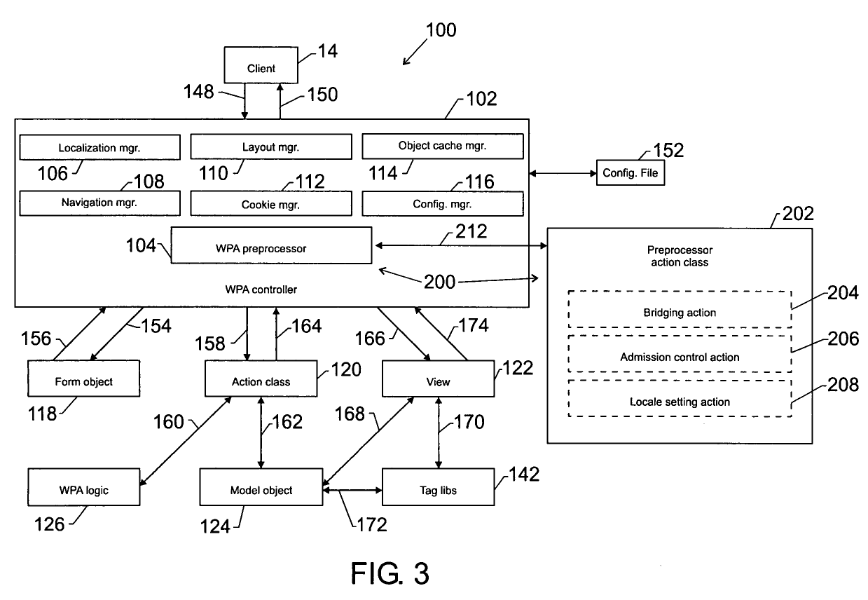

Turning now to FIG. 3, an exemplary preprocessing system 200 of the WPA 100 is described according to certain embodiments of the present technique. As illustrated, a preprocessing system 200 comprises the WPA preprocessor 104 and one or more sample preprocessor action classes 202, such as a bridging action 204, an admission control action 206, and a locale setting action 208. As described in further detail below, a preprocessor action of the preprocessing system 200 comprises one or more settings, functions, logical operations, or other features that are engaged or executed before the regular course of processing an incoming request 148. Accordingly, in operation of the WPA 100, the WPA controller 102 engages the WPA preprocessor 104 prior to regular processing of the incoming request 148 received from the client 14. The WPA preprocessor 104 searches for any preprocessor action classes 202 registered to the particular portal of the incoming request 148 and, if identified, the WPA preprocessor 104 invokes the registered action class, as indicated by arrow 212. For example, the preprocessor action classes 202 may be registered or mapped to the portal in a variety of configuration files or other mechanisms, such as the configuration file 152. Upon execution of the registered action class 202, the WPA preprocessor 104 can redirect to a remote target or URI, forward to a local target or URI, or simply return to the WPA controller 102. Accordingly, these preprocessor functions precede the normal processing flow indicated by arrows 154 through 174, as discussed above with reference to FIG. 2.

The preprocessor action classes 202 may comprise a variety of preprocessing functions to reduce repetition of common actions performed for each incoming request 148 during a particular session on a portal. For example, the sample bridging action 204 can function as an interface between different architectures and programming languages. One example is a bridging interface between the WPA 100 and a Common Gateway Interface (CGI), which may be written in the Practical Extraction and Report Language (PERL). In operation, if a user attempts to access pages associated with different architectures, then the bridging action 204 ensures that data is shared and communicated between the different architectures.

The sample admission control action 206 also can provide a variety of preprocessor functions, which reduce repetition of common admission actions for a particular portal. For example, if the user is initially directed to a particular server for the web application, then the admission control action 206 may ensure that the user remains at that particular server for the duration of the session. In this manner, the admission control action 206 ensures that all state information stored on the server is available for the duration of the session.

The sample locale setting action 208 functions to reduce repetition of common locale actions, such as described above with reference to the localization manager 106. For example, the WPA preprocessor 104 may invoke the locale setting action 208 to customize user viewing based on specific locale information, such as a language, a country, and a variant (e.g., a dialect). These locale settings are maintained for the duration of the user's session on the portal, thereby ensuring that the action classes 120 utilize the appropriate locale information for the normal processing of the incoming request 148, as indicated by arrows 154 through 174.

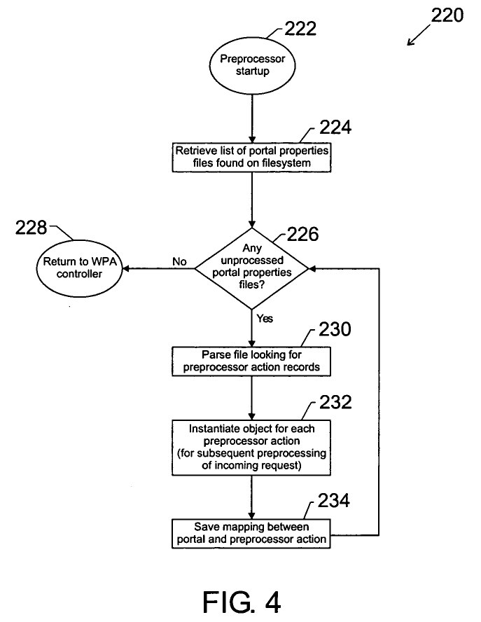

As noted above, one or more preprocessor action classes 202 can be registered or mapped to each portal, such that the appropriate preprocessor actions can be identified and executed prior to the normal processing of the incoming request 148. FIG. 4 is flow chart illustrating an exemplary preprocessing setup process 220 of the preprocessing system 200 according to certain embodiments of the present technique. As illustrated, the process 220 begins by searching for preprocessor action classes 202 associated with the portal of the incoming request 148 (block 222). Accordingly, the process 220 retrieves a list of configuration or properties files associated with the portal of the incoming request 148 (block 224). For example, the process 220 may retrieve “portal.properties” files stored on the file system in a directory, such as “IWEB-INF/<service>/properties/portal.properties,” where <service> is the name of the service or application.

As illustrated, the process 220 then queries for any unprocessed portal properties files (block 226). If the process 220 did not retrieve any properties files at block 224, then the process 220 returns control to the WPA controller 102 at block 228. Otherwise, if the process retrieved one or more properties files at block 224, the process 220 proceeds to parse the first file looking for preprocessor action records (block 230). For example, the preprocessor action records in the “portal.properties” file may have the format “<portal>.preprocessor.actions,” which corresponds to the appropriate preprocessor action classes 202 registered to the portal of the incoming request 148. Depending on the particular portal, the process 220 may identify the bridging action 204, the admission control action 206, the locale setting action 208, and/or one or more other preprocessor actions.

After parsing the properties file, the process 220 proceeds to instantiate an object for each of the identified preprocessor actions for subsequent preprocessing of incoming requests 148 (block 232). At block 234, the process 220 saves the mapping between the portal and the preprocessor action, thereby facilitating the identification and execution of preprocessor actions for subsequent incoming requests. The process 220 then returns to query block 226 to process any remaining portal properties files. If the process 220 identified one or more unprocessed portal properties files, then the process 220 continues through blocks 230, 232, and 234 as described in detail above. Otherwise, if there are no remaining portal properties files, then the process 220 returns control to the WPA controller at block 228.

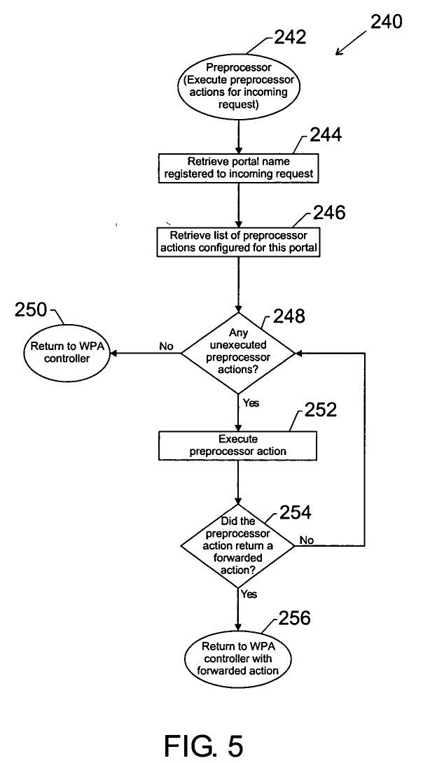

In operation, the preprocessing system 200 uses the preprocessor objects and mappings of the process 220 for preprocessing each incoming request 148. FIG. 5 is flow chart illustrating an exemplary preprocessing process 240 of the preprocessing system 200 according to certain embodiments of the present technique. At block 242, the process 240 invokes the preprocessor 104 to execute preprocessor actions for the incoming request 148. The process 240 then proceeds to retrieve the portal name registered to the incoming request 148 (block 244). The process 240 also retrieves a list of the preprocessor actions mapped or configured for this portal (block 246). For example, the process 240 may utilize the preprocessor mapping provided in block 234 of the preprocessing setup process 220.

At block 248 of FIG. 5, the process 240 queries for any unexecuted preprocessor actions. If the process 240 does not identify any unexecuted preprocessor actions at block 248, then the process 240 returns control to the WPA controller 102 (block 250). Otherwise, the process 240 proceeds to execute the first (or only) preprocessor action (block 252). At block 254, the process 240 queries whether the preprocessor action returned a forwarded action. If the executed preprocessor action did return a forwarded action, then the process 240 returns control to the WPA controller with the forwarded action (block 256). Otherwise, the process 240 returns to block 248 to identify any unexecuted preprocessor actions. Again, if no preprocessor actions remain unexecuted, then the process 240 returns control to the WPA controller 102. Otherwise, the process 240 continues through blocks 252, 254, and 256 with the next preprocessor action. After processing all preprocessor actions, the WPA controller 102 proceeds to process the incoming request 148 with the normal course of actions.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

1. A system comprising:
a controller generator that is adapted to provide an application with a controller that receives requests for data from users and responds to the requests by obtaining requested data; and
a preprocessor manager that is adapted to process a preprocessor action for use by the controller during a user session at a portal.

2. The system set forth in claim 1, wherein the controller is adapted to invoke the preprocessor manager before processing an incoming request for the user session.

3. The system set forth in claim 1, wherein the preprocessor manager is adapted to map the preprocessor action to the portal.

4. The system set forth in claim 1, wherein the preprocessor manager is adapted to instantiate a session-scoped object for the preprocessor action.

5. The system set forth in claim 1, wherein the preprocessor action comprises an architectural bridge adapted to facilitate communication between different server architectures.

6. The system set forth in claim 1, wherein the preprocessor action comprises an admission control adapted to continue interaction with a desired server for the duration of the user session.

7. The system set forth in claim 1, wherein the preprocessor action comprises a locale setting control adapted to set locale information for the duration of the user session.

8. The system set forth in claim 1, comprising a model and a view separate from one another and separate from the controller, wherein the model is adapted to provide an application state for the application and the view is adapted to provide a view presentation for the application.

9. A method of creating applications, the method comprising:
creating, with a processor-based device, a controller that receives requests for data from users and responds to the requests by obtaining requested data; and
providing a preprocessor manager that executes a desired action to produce information accessible by the controller for a desired time of incoming user requests.

10. The method set forth in claim 9, comprising configuring the preprocessor manager to execute the desired action before processing the incoming user requests.

11. The method set forth in claim 9, comprising mapping the desired action to a portal.

12. The method set forth in claim 9, comprising eliminating repetitious execution of the desired action for each of the incoming requests.

13. The method set forth in claim 9, comprising configuring the preprocessor manager to instantiate a session-scoped object for the desired action during preprocessor startup.

14. A system for creating applications, the system comprising:
means for creating a controller that provides control functions for an application, the controller being adapted to receive requests for data from users and respond to the requests by obtaining requested data; and
means for preprocessing an action to produce session-scoped information accessible by the controller during incoming user requests.

15. The system set forth in claim 14, wherein the means for preprocessing comprises means for bridging communication between at least two architectures.

16. The system set forth in claim 14, wherein the means for preprocessing comprises means for controlling admission to a portal.

17. The system set forth in claim 14, wherein the means for preprocessing comprises means for setting locale information.

18. A program for creating applications, comprising:
a machine readable medium;
a preprocessor manager stored on the machine readable medium and adapted to provide reusable settings for processing user requests from an application prior to processing the user requests.

19. The program set forth in claim 18, comprising controller logic stored on the machine readable medium and adapted to receive the user requests for data from users and respond to the user requests by obtaining requested data.

20. The program set forth in claim 18, comprising action classes stored on the machine readable medium and adapted to perform actions for processing the user request.

21. The program set forth in claim 18, wherein the preprocessor manager comprises preprocessor action classes mapped to a portal and adapted to execute logic common to the portal to provide the reusable settings.
